(19) United States
(12) Patent Application Publication
(10) Pub. No.: US 2014/0287144 A1
(43) Pub. Date: Sep. 25, 2014

(54) Process and Method for Cellulose Acetate Manufacturing Waste Product Recycling

(71) Applicants: Blake Burich, Dublin, OH (US); Charles L. Putnam, Dublin, OH (US)

(72) Inventors: Blake Burich, Dublin, OH (US); Charles L. Putnam, Dublin, OH (US)

(21) Appl. No.: 14/216,165

(22) Filed: Mar. 17, 2014

Related U.S. Application Data
(60) Provisional application No. 61/788,862, filed on Mar. 15, 2013.

(51) Int. Cl. C08J 11/06

(52) U.S. Cl. CPC C08J 11/06; C08J 2301/12
USPC 427/290

(57) ABSTRACT

The present invention is directed to processes and methods for recycling the waste products from the manufacture of cellulose acetate materials, using the example of cigarette butt manufacturing, in this case, but also applies to cellulose acetate production for other materials. Once the cellulose acetate containing materials are processed, they may be acceptable for use in a multitude of applications from insulation to reinforcements and decorative pieces.

### CLAIM OF PRIORITY

This application claims priority to U.S. Provisional Application Ser. No. 61/788,862 which was filed on Mar. 15, 2013 and which is incorporated by reference.

### BACKGROUND AND SUMMARY OF THE INVENTION

Reference is made to issued U.S. Pat. No. 7,560,059 the contents of which are incorporated by reference as if fully recited herein.

The present invention relates generally to the process for recycling by-products including off-quality waste from the manufacture and testing of cellulose acetate products such as cigarette butts, for example. More particularly, the present invention relates to a process and method for dealing with discarded materials from the manufacture of cellulose acetate and cigarette butts. Focus in this application is on Post-Industrial waste but directly correlates to cleansed Post-Consumer fiber materials as once cleaned, they are for all practical purposes the same marketable material.

Cigarette filters are composed of a bundle of 12,000 plastic-like cellulose acetate fibers. It can take years, for the fibers to decay into a plastic powder that can't be seen.

In the manufacturing process, there are filter presses that are utilized for filtering “wet” cellulose acetate before finished goods are produced through a spinning process that evacuates the “wet” carrier. These filters are essentially fabric-like filters that contain a sandwich of pure and dry cellulose acetate in large (approximately two foot by two foot squares and one to three inches thick) fairly uniform pieces. One location can produce millions of pounds of filter press pad waste each year and this currently is being sent to landfill.

Through the quality process, tow product, or the actual butt material—made up of cellulose acetate fiber are determined to be off-quality and in many cases taken to landfill rather than reprocessed. This is most usually referenced as “bale” material and is also being sent to landfill.

Quality checks for cigarette filters include thousands of “tubes” or “rods” each day. These tubes are essentially paper surrounding cellulose acetate to determine final quality of product before sending tow (cellulose acetate filter materials) to customers for use. The tubes are approximately the length of a “100” cigarette and come in Western and European sizes. This material is also being landfilled.

The present invention is directed to processes and methods for recycling the waste products from the manufacture of cellulose acetate materials, using the example of cigarette butt manufacturing, in this case, but applies to any cellulose acetate production for other materials also. Once the cellulose acetate containing materials are processed, they may be acceptable for use in a multitude of applications from insulation to reinforcements and decorative pieces. One such application makes any of the fibrous materials suitable for encapsulation within plastics for use as reinforcement in automotive parts—cellulose acetate; post-industrial or post-consumer waste cut into 1 to 6 mm length has undergone preliminary testing encapsulated in polypropylene at 10% and 20% (30% and 40% will be tested) through extrusion and has rendered outstanding results (as seen in FIGS. 3A-G) proving advantages in strength while providing potential for wall thickness reduction that would eliminate weight and have some potentially significant impact in the ability to increase gas mileage.

This same fiber, when prepared properly (matching fiber length effectively with process), also creates beneficial fiber additives that can be encapsulated and utilized in other products such as concrete and asphalt to not only use as a filler material but also provide significant advantages in strength. Use of fiber in plastics and other materials is not a new concept. However, the use of this particular waste fiber is quite novel. The cellulose acetate fibers can replace any fiber technologies available in a multitude of industries. While encapsulation provides for retention of materials in any specified manner, the strength benefits provide the advantages necessary to use the cigarette butt materials, both post-industrial and post-consumer, in this manner.

In accordance with a preferred embodiment of the invention, the filter press wastes, or typically referred to as press pads, can be ground up to smaller pieces (this can be anywhere from ½ inch more or less in size—depending on intended application). Once ground it is then wet with acetone to make an almost Mache' out of the residual cellulose acetate and the pulpous film covering the press pads. Additional cellulose may be introduced by wetting the other waste fiber materials with acetone. Colorants may then also be added to the clear/white mixture as desired in any application. Resultant mix is then molded and allowed to dry. Any concrete products may be replaced with the resulting very strong and lighter weight material that possesses R-value for insulation applications for example. This material may have additives for UV protection, or coatings as desired.

Additionally, due to the size and strength aspects of the press pads, they can be cut in any manner to different shapes and sizes and may even be attached together for creating long-lasting products for decorative purposes such as stepping stones or wall hangings

Other fibrous tow or other waste cellulose acetate materials can also be liquefied with acetone (or any other solvent one who practices in the art may select) and placed through processes referenced in U.S. Pat. No. 7,560,059 and U.S. Provisional Patent Application No. 61/788,862 the contents of which is incorporated by reference as if fully recited herein.

Waste fibers may also be placed through processes to cut the fibers into desired sizes for incorporation and encapsulation into other products such as plastics or concrete or other materials one may select to increase strength and or render lighter weight. For example, fibers of 1 mm to 6 mm are most desired for inclusion with Olefin for automotive part production. Larger cuts may be desired for applications such as insulation as cellulose acetate is well known for its insulating characteristics.

In addition to the novel features and advantages mentioned above, other features and advantages of the present invention will be readily apparent from the following descriptions and exemplary embodiments.

### BRIEF DESCRIPTION OF THE DRAWINGS

FIG. 1 is a flow chart of an exemplary embodiment of a process of the present invention.

FIG. 2 is a flow chart of an exemplary embodiment of a process of the present invention.

FIG. 3A is a chart of the mechanical properties showing of polypropylene (PP) at 10% and 20% encapsulation with cellulose acetate (CA) and with maleic anhydride (MA).

FIG. 3B is a bar chart showing tensile strength (T.S.) in megapascals (MPa).

FIG. 3C is a bar chart showing elongation at yield (EAY) in percent (%).

FIG. 3D is a bar chart showing tensile modulus (T.M.) in gigapascals (GPa).

FIG. 3E is a bar chart showing Newton inch strength (NIS) in foot pounds per inch (ft. lb/in).

FIG. 3F is a bar chart showing Young's modulus (Y.M.) in gigapascals (GPa).

FIG. 3G is a line chart showing flexural modulus (F.M.) and flexural strength in gigapascals (GPa) and megapascals (MPa), respectively.

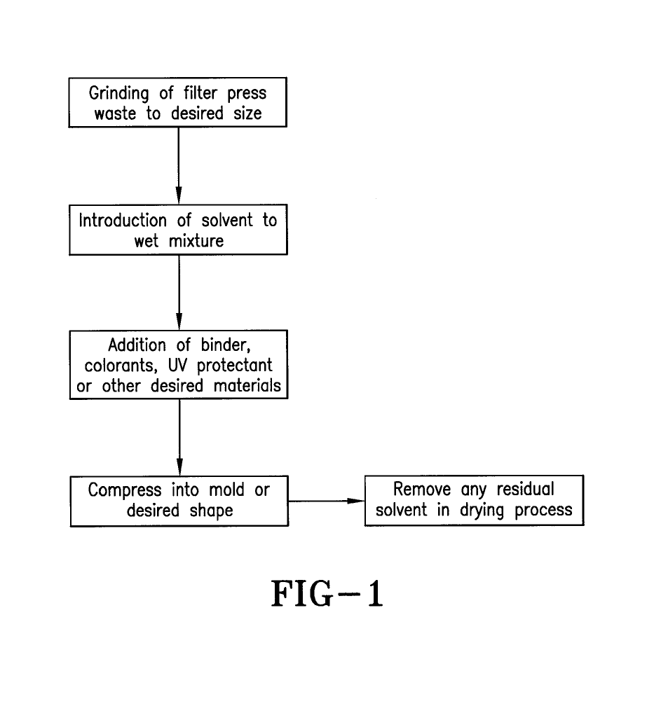

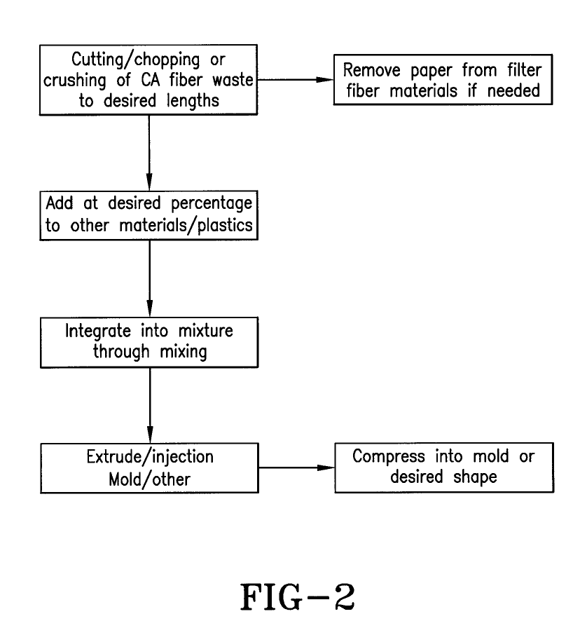

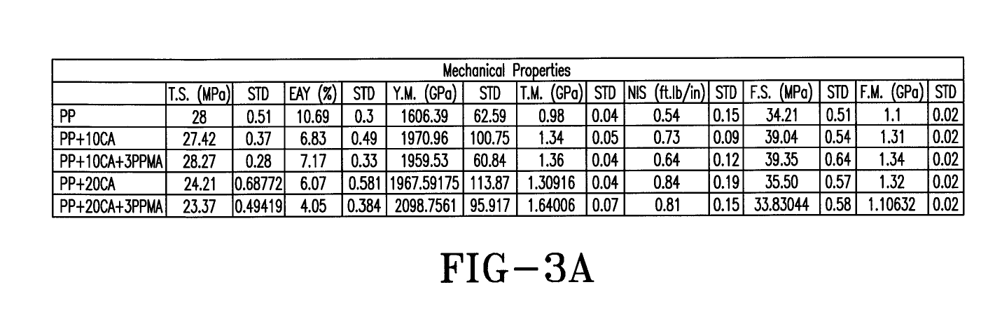

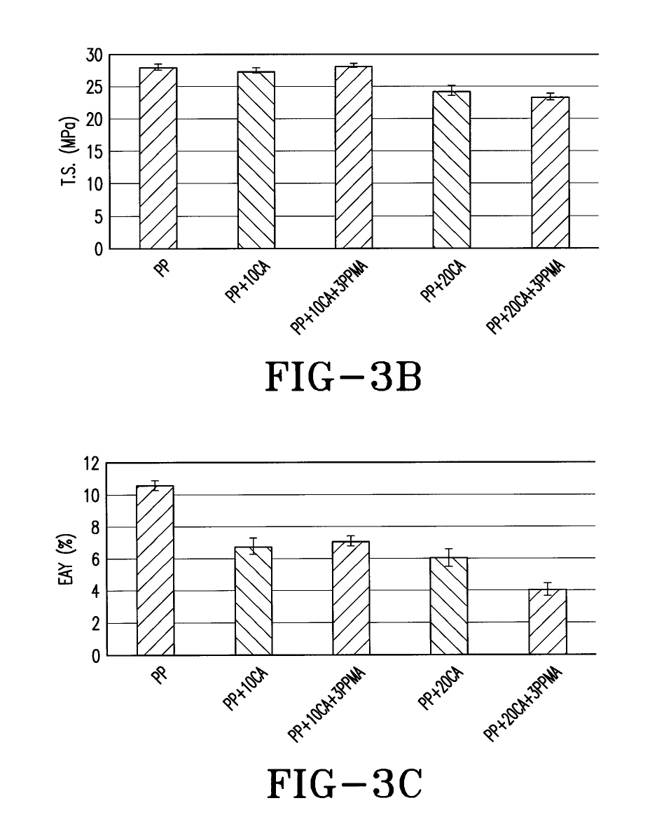

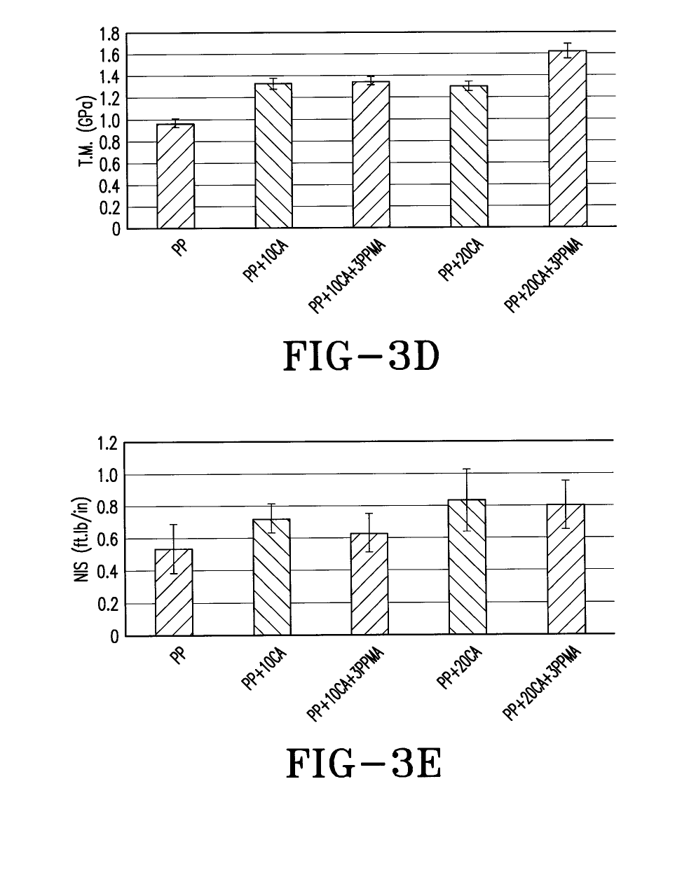

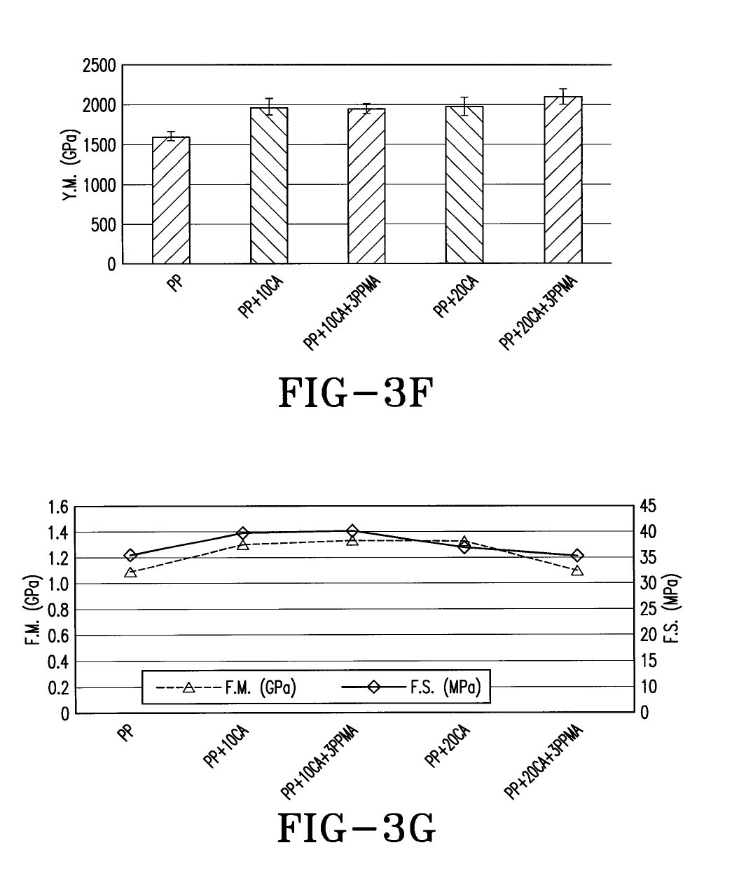

### DETAILED DESCRIPTION OF EXEMPLARY EMBODIMENT(S)

### EXAMPLE 1

Filter press waste materials from cellulose acetate manufacturing are removed from the waste stream and ground up to any size desired. Larger particles will render a more rough appearance while smaller particles will assist in gaining smoothness. The resultant grind is then wet with acetone (or another solvent know to those in the art). Additional cellulose acetate may be introduced to increase integrity. This material can then be colored, added to with anything that may have resultant characteristics desired, such as UV protection, and then placed into a mold. Molding may be improved with compression. Once allowed to cure or dry, it is removed from the mold. Coatings may be applied as applicable.

### EXAMPLE 2

Press pads may be cut into any size or shape and used for decorative purposes including stepping stones, for example, or any other decorative or functional pieces one experienced in the art may consider.

### EXAMPLE 3

Other cellulose acetate waste materials are liquefied with acetone (or any other solvent one who practices in the art may select) and placed through processes referenced in U.S. Pat. No. 7,560,059 the contents of which is incorporated by reference as if fully recited herein.

### EXAMPLE 4

Any waste fibers, or other cellulose acetate waste material as deemed acceptable in applications known to those in the art are placed through a number of chosen processes to cut the fibers into desired sizes for incorporation into other products such as plastics or concrete or other materials one experienced in the art may select. For example, fibers of 1 mm to 6 mm are most desired for inclusion with Olefin for automotive part production. Larger cuts may be desired for applications such as insulation as cellulose acetate is well known for its insulating characteristics. Residual paper from rods may be removed through varying processes, one of which is heat, to loosen any adhesive.

### EXAMPLE 5

Other waste cellulose acetate materials including fibers are liquefied with acetone (or any other solvent one who practices in the art may select) and placed through processes to introduce colorants, plasticizers or any other desired components. Mixture can then be pelletized and utilized for injection, extrusion or other molding.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A process for recycling cellulose acetate waste products from post-industrial or post-consumer materials, said process comprising:
separating cellulose acetate fiber materials from any other materials in said post-industrial or post-consumer materials;
cutting the fibers to specified lengths; and
incorporating and encapsulating the cellulose acetate fibers.
